(19) United States
(12) Patent Application Publication
(10) Pub. No.: US 2025/0077245 A1
(43) Pub. Date: Mar. 6, 2025

(54) METHOD AND APPARATUS FOR EXECUTING PROGRAM SERVICE LOGIC, DEVICE AND MEDIUM

(71) Applicant: Lemon Inc., Grand Cayman (KY)

(72) Inventors: Hua LIU, Beijing (CN); Lei MA, Beijing (CN)

(21) Appl. No.: 18/817,627

(22) Filed: Aug. 28, 2024

(30) Foreign Application Priority Data
Aug. 28, 2023 (CN) 202311092071.4

(51) Int. Cl. G06F 9/448

(52) U.S. Cl. CPC G06F 9/4496

(57) ABSTRACT

Embodiments of the present disclosure provide a method and apparatus for executing program service logic, a device and a medium. The method includes: dividing a plurality of logic blocks included in a target program into a plurality of service logic block sets according to a service to which a logic block belongs; concatenating the plurality of the service logic block sets into a service logic chain which is used for executing respective service logic block set in sequence according to an order of the respective service logic block in the service logic chain. Through the method of the present disclosure, service processing logics of different services can be decoupled, which is convenient for distinguishing and maintaining the processing logics of different services and avoiding the mutual interference of the processing logics of different services during execution.

### CROSS-REFERENCE TO RELATED APPLICATIONS

This application claims the priority to and benefits of the Chinese Patent Application, No. 202311092071.4, which was filed on Aug. 28, 2023. The aforementioned patent application is hereby incorporated by reference in their entireties.

### TECHNICAL FIELD

The embodiments of the present disclosure relate to the technical field of computers, in particular to a method and apparatus for executing program service logic, a device and a medium.

### BACKGROUND

Existing applications may include processing logic for multiple services, which are often coupled in the production process of the applications. Coupled service processing logic, on the one hand, can lead to the unclear structure of processing logic and difficult to be maintained. On the other hand, it can also cause the processing logic of different services to interfere with each other and cause processing errors.

### SUMMARY

The embodiments of the present disclosure provide a method and apparatus for executing program service logic, a device and a medium.

According to a first aspect, the present disclosure provides a method for executing program service logic, including:
dividing a plurality of logic blocks included in a target program into a plurality of service logic block sets according to a service to which a logic block belongs, wherein each service logic block set of the plurality of the service logic block sets includes one or more logic blocks; and
concatenating the plurality of the service logic block sets into a service logic chain, wherein the service logic chain is used for executing respective service logic block set in sequence according to an order of the respective service logic block in the service logic chain.

According to a second aspect, the present disclosure provides an apparatus for executing program service logic, including:
a dividing unit configured to divide a plurality of logic blocks included in a target program into a plurality of service logic block sets according to a service to which a logic block belongs, wherein each service logic block set of the plurality of the service logic block sets includes one or more logic blocks; and
an execution unit configured to concatenate the plurality of the service logic block sets into a service logic chain, wherein the service logic chain is used for executing respective service logic block set in sequence according to an order of the respective service logic block in the service logic chain.

According to a third aspect, the present disclosure provides a computer-readable storage medium with a computer program stored thereon, wherein the computer program, when executed in a computer, causes the computer to perform the method according to the first aspect.

According to a fourth aspect, the present disclosure provides an electronic device. The electronic device includes a memory and a processor, wherein executable codes are stored in the memory, and the executable codes, when executed by the processor, cause the processor to perform the method according to the first aspect.

The embodiments of the present disclosure provide a method and apparatus for executing program service logic, a device and a medium. Firstly, a plurality of logic blocks included in a target program is divided into a plurality of service logic block sets according to a service to which a logic block belongs, wherein each service logic block set of the plurality of the service logic block sets includes one or more logic blocks. Then, the plurality of the service logic block sets are concatenated into a service logic chain, wherein the service logic chain is used for executing respective service logic block set in sequence according to an order of the respective service logic block in the service logic chain. By the method of the present disclosure, service processing logics of different services can be decoupled, and it is convenient to distinguish and maintain the processing logics of different services. And thus, it can avoid mutual interference of the processing logics of different services during execution.

### BRIEF DESCRIPTION OF DRAWINGS

FIG. 1 shows a schematic diagram of a target program including a plurality of logic blocks;

FIG. 2 shows a schematic diagram of a method for executing program service logic according to embodiments of the present disclosure;

FIG. 3 shows a flowchart of a method for executing program service logic according to embodiments of the present disclosure;

FIG. 4 shows a schematic diagram of removing a service logic block set from a service logic chain and adding a service logic block set to a service logic chain according to embodiments of the present disclosure;

FIG. 5 shows a schematic diagram of an asynchronous execution of service logic block sets according to embodiments of the present disclosure;

FIG. 6 shows a schematic diagram of an internal execution chain of a service logic block set according to embodiments of the present disclosure;

FIG. 7 shows a schematic block diagram of an apparatus for executing program service logic according to embodiments of the present disclosure;

FIG. 8 shows a structural schematic diagram of an electronic device according to embodiments of the present disclosure; and

FIG. 9 shows a schematic structural diagram of a storage medium according to embodiments of the present disclosure.

### DETAILED DESCRIPTION

In the following, the technical scheme provided by the present disclosure will be further described in detail with the accompanying drawings and examples. It can be understood that the specific embodiments described herein are only used to explain the related invention, but not to limit the invention. In addition, for the convenience of description, only the parts related to the invention are shown in the accompanying drawings. It should be noted that the embodiments of the present disclosure and the features in the embodiments can be combined with each other without conflict.

In the description of the implementations of the present disclosure, the term “including” and similar terms should be understood as open inclusion, that is, “including but not limited to”. The term “based on” should be understood as “at least partially based on”. The terms “one implementation” or “the implementation” should be understood as “at least one implementation”. The term “some implementations” should be understood as “at least some implementations”. Other explicit and implicit definitions may be included below.

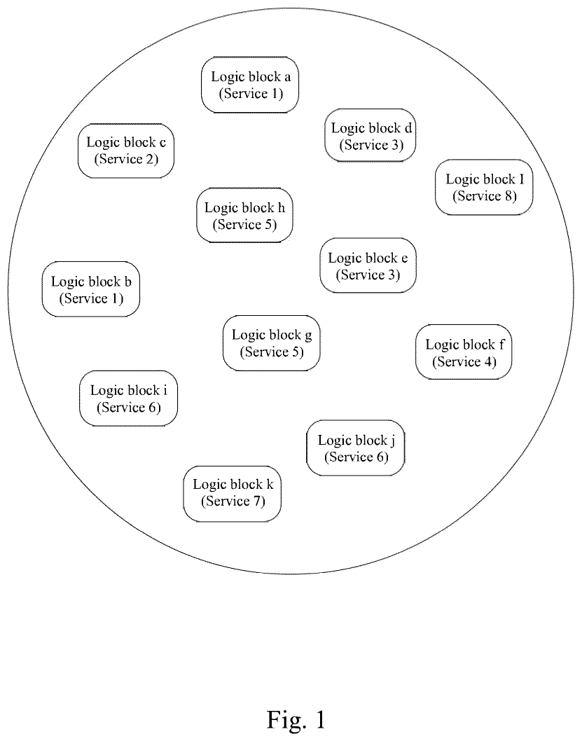

As mentioned above, existing applications often include processing logic for multiple services, and these service processing logics are often coupled together in the production process of the applications. Coupled service processing logics will lead to unclear structure of processing logics of different services, making it difficult for developers to distinguish and maintain them, and increasing the difficulty of adding or removing service processing logics from programs. In addition, the processing logics of different services will interfere with each other, leading to processing errors. For example, FIG. 1 shows a schematic diagram in which a target program includes a plurality of logic blocks. As shown in FIG. 1, for example, the target program includes a plurality of logic blocks: logic block a, logic block b, logic block c . . . logic block 1. These logic blocks can be used for service logic processing of different services (such as service 1, service 2, . . . service 8) respectively. For example, logic block a and logic block b are used for service logic processing of service 1, logic block c is used for service logic processing of service 2, logic block d and logic block e are used for service logic processing of service 3, and so on. In the production process of the target program, these logic blocks are often mixed during the production process rather than separated by different services. Therefore, it is often difficult for multiple logic blocks belonging to a specific service to be executed centrally, but cross-executed with logic blocks belonging to other services, which easily leads to mutual interference between service logic processing of different services. For example, in FIG. 1, logic block a of service 1 is used to read data D from a data source, and logic block b of service 1 is used to perform interface presentation based on the data D read by logic block a. However, between logic block a and logic block b, such as logic block c of service 2 may be performed for updating the data D, however, logic block b still uses the data D read by logic block a, resulting in that the data D displayed by logic block b is not its current value. For another example, if the logic block c displays the data D while updating the data D, the data D displayed by logic block c will be different from that displayed by the logic block b. The inconsistent performance of the same function in different scenarios will also have a great impact on the user experience. In addition, coupled service processing logics are not convenient for multi-thread parallel processing. Therefore, it leads to problems such as heavy burden of single thread and long time-consuming data loading, especially when the interface (UI) is processed by single thread, which can lead to application jamming.

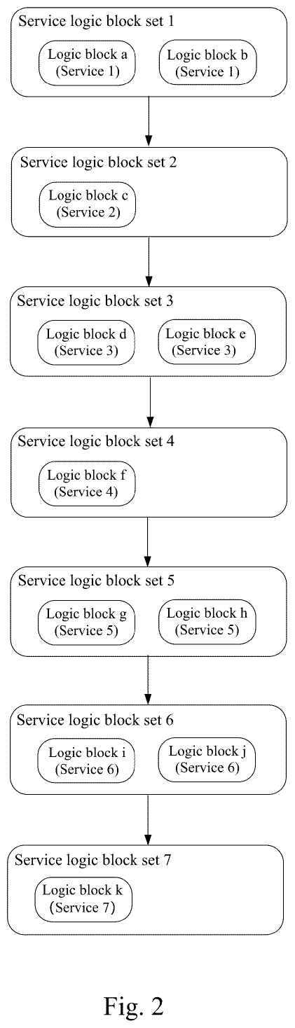

In order to solve the above technical problems, embodiments of the present disclosure provide a method for executing program service logic. In some embodiments, a plurality of logic blocks included in the target program can be divided into a plurality of service logic block sets according to the service to which each logic block belongs, and each service logic block set includes one or more logic blocks. And. the plurality of the service logic block sets are concatenated into a service logic chain. The service logic chain is used for executing respective service logic block set in sequence according to an order of the respective service logic block in the service logic chain. FIG. 2 shows a schematic diagram of the method for executing program service logic according to embodiments of the present disclosure. As shown in FIG. 2, for example, a plurality of logic blocks included in the target program (such as shown in FIG. 1): logic block a, logic block b, logic block c . . . logic block 1, can be divided into a plurality of service logic block sets according to their respective services, such as service logic block set 1 and service logic block set 2. Among them, for example, service logic block set 1 includes logic block a and logic block b to which service 1 belongs, and service logic block set 2 includes logic block c to which service 2 belongs, and so on. Then the service logic block sets are concatenate to form a service logic chain, and when the service logic chain is executed, the service logic block sets are executed in turn according to the order of the service logic block sets in the service logic chain.

The advantages of the method of the present disclosure are as follows: in a first aspect, by constructing different service logic block sets for different services, the service processing logic of different services can be decoupled, and the processing logic of different services can be easily distinguished after decoupling. Therefore, when, for example, it is desired to refer to the processing logic code of a specific service, it is very easy to locate it without referring to a large number of processing logic codes of other services, and the processing logic code for referring to a specific service can be separated from it. In a second aspect, the service logic block sets of different services are assembled to form a service logic chain, which makes the execution of the logic blocks of different services orderly. Therefore, the service processing logics of different services are prevented from interfering with each other during execution. In a third aspect, it can add new service functions or remove expired service functions, for example, by conveniently removing or adding service logic block sets in the service logic chain. In a fourth aspect, the service logic block set of a specific service can be executed asynchronously with other service logic block sets of the service logic chain, thus, for example, the loading time of a specific function and the execution load of the main thread of the service logic chain are reduced, and the user experience of the application can be improved.

The detailed process of the method of the present disclosure is further described below.

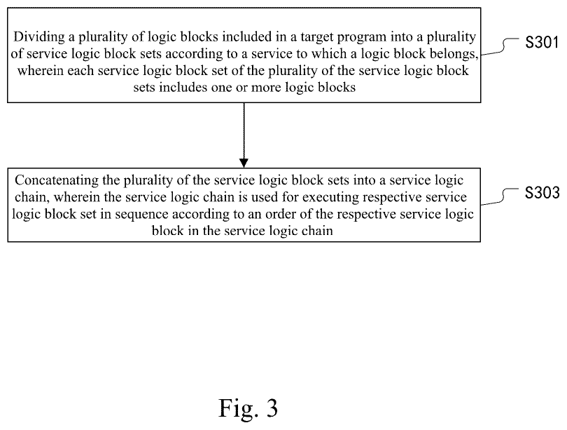

FIG. 3 shows a flowchart of a method for executing program service logic according to embodiments of the present disclosure. As shown in FIG. 3, the method at least includes the following steps:

Step S301, dividing a plurality of logic blocks included in a target program into a plurality of service logic block sets according to a service to which a logic block belongs, wherein each service logic block set of the plurality of the service logic block sets includes one or more logic blocks; and

Step S303, concatenating the plurality of the service logic block sets into a service logic chain, wherein the service logic chain is used for executing respective service logic block set in sequence according to an order of the respective service logic block in the service logic chain.

First, in step S301, a plurality of logic blocks included in the target program are divided into a plurality of service logic block sets according to the service to which the logic blocks belong, and each service logic block set includes one or more logic blocks.

In this step, a plurality of logic blocks included in the target program can be divided into a plurality of service logic block sets according to the service to which they belong, and each service logic block set can include one or more logic blocks. In different embodiments, the target program can be different specific application programs, which is not limited in this specification.

A logic block can usually be a program block consisting of one to more lines of code or instruct. The target program can be used for processing various services, and each logic block included in the target program can be used for service processing related to the same or different services. In different embodiments, the types of programming languages on which the codes or instructions included in the logic block are based may also be different. In one implementation, different logic blocks to which the same service belongs can be used for different types of service processing. In one implementation, the target program can be a client program, and each logic block can be used for data processing for its own service, for example, one or more of reading data, calculating data, updating data or displaying data.

In different embodiments, according to the different services used by the target program and the different logic blocks included, the service logic block sets obtained by division can be different, and the specific logic blocks included in each service logic block set after division can also be different, which is not limited in this specification. In the example shown in FIG. 2, for example, a plurality of logic blocks included in the target program (as shown in FIG. 1: logic block a, logic block b, logic block b . . . logic block 1) can be divided into a plurality of service logic block sets according to their respective services (service 1, service 2 . . . service 7), such as service logic block set 1, service logic block set 2 . . . service logic block set 3. Among them, service logic block set 1 includes, for example, logic block a and logic block b to which service 1 belongs, and service logic block set 2 includes logic block b to which service 2 belongs, and so on.

Then, in step S303, the plurality of service logic block sets are connected in series into a service logic chain, and the service logic chain is used for executing each service logic block set in turn according to the order of each service logic block set in the service logic chain.

In this step, the plurality of service logic block sets obtained in step S301 can be connected in series to obtain a service logic chain. In the example shown in FIG. 2, for example, service logic block set 1, service logic block set 2, . . . , and service logic block set 7 can be connected in series to form a service logic chain. The service logic chain can be used to execute each service logic block set in turn according to the order of each service logic block set in the service logic chain. It should be noted that the serial order of service logic block set 1, service logic block set 2, . . . , and service logic block set 7 in FIG. 2 is only an example and does not constitute a limitation. In different embodiments, the serial order of a plurality of service logic block sets or the way to determine the serial order may be different, which is not limited herein. In one example, for example, they can be connected in series in a random order. In another example, they can be connected in series according to service priority.

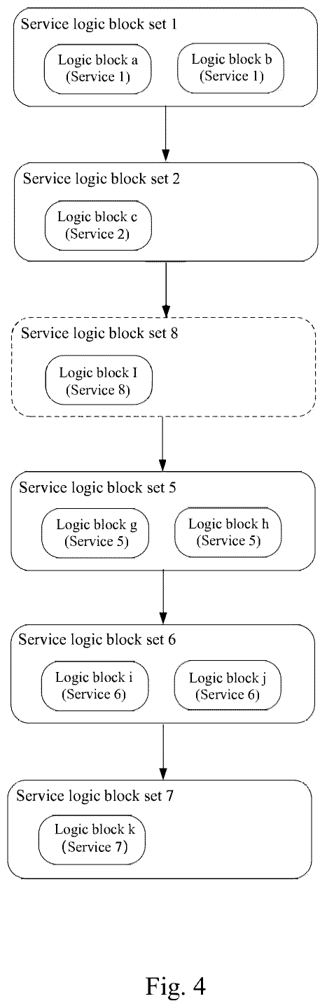

A service logic block set can be added to the service logic chain or removed from the service logic chain, so that it is convenient to add processing logic such as new service or remove processing logic such as expired service. Therefore, in one implementation, a specified first service logic block set can be removed from the service logic chain; if there are an upper-level service logic block set and a lower-level service logic block set of the first service logic block set, the lower-level service logic block set is linked behind the upper-level service logic block set. In another implementation, a specified second service logic block set can be inserted at a specified position of the service logic chain; if there is an upper-level logic block set at the specified position of the service logic chain, the second service logic block set is linked after the upper-level logic block set; and if there is a lower-level logic block set at the specified position of the service logic chain, the lower-level logic block set is linked to the second service logic block set. FIG. 4 shows a schematic diagram of removing a service logic block set from a service logic chain and adding a service logic block set to a service logic chain according to embodiments of the present disclosure. As shown in FIG. 4, for example, a service logic block set 3 and service logic block set 4 can be removed from the service logic chain as shown in FIG. 2. And, a service logic block set 8 can be added between the service logic block set 2 and the service logic block set 5, wherein the service logic block set 8 includes a logic block 1 for data processing of the service 8.

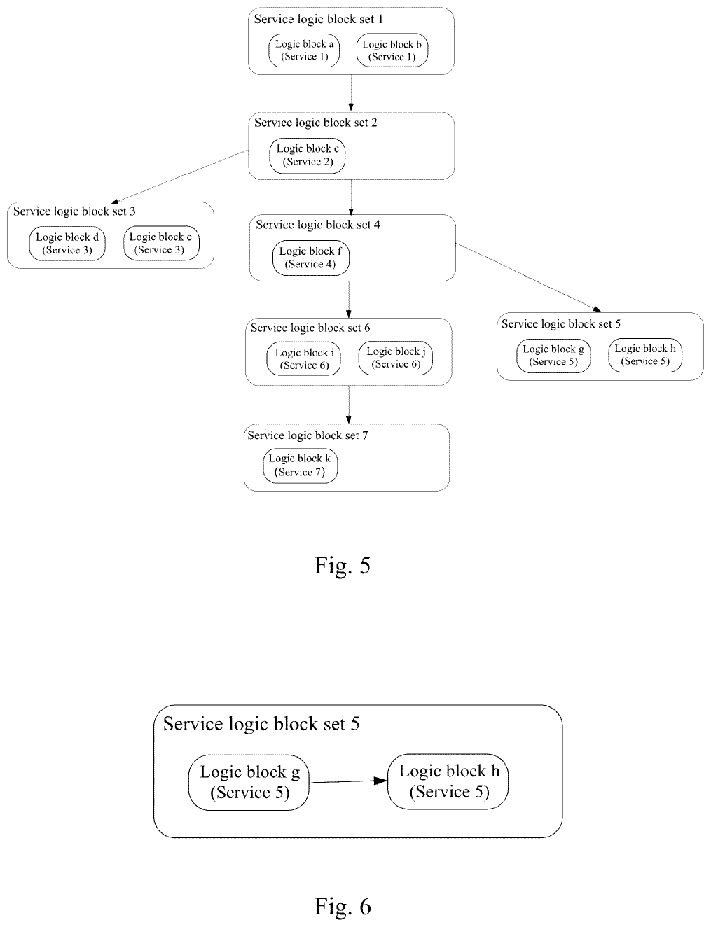

In order to improve the execution efficiency of the service logic chain or the execution load of the main thread of the service logic chain, some service logic block sets in the service logic chain can also be executed asynchronously with other service logic block sets. Therefore, in one implementation, the service logic chain may further include an asynchronous service logic block set, which is executed asynchronously with other service logic block sets in the service logic chain. In a specific implementation, the other service logic block sets are executed by the main thread of the service logic chain, and the asynchronous service logic set is executed by other threads different from the main thread. FIG. 5 shows a schematic diagram of an asynchronous execution of service logic block sets according to embodiments of the present disclosure. As shown in FIG. 5, for example, the execution of the service logic block set 3 after the service logic block set 2 can be asynchronous with the execution of the service logic block set 4, such that the execution of the service logic block set 4 does not have to wait for the completion of the service logic block set 3. For example, the execution of the service logic block set 5 after the service logic block set 4 can be asynchronous with the execution of the service logic block set 6, such that the execution of the service logic block set 6 does not have to wait for the completion of the execution of the service logic block set 5. Asynchronous execution of service logic block set 3 and service logic block set 5 can be handled by other threads besides the main thread.

As mentioned above, different sets of service logic blocks can be executed in their own order in the service logic chain. In one implementation, the execution of any service logic block set itself can sequentially execute the logic blocks according to the internal order of the logic blocks included in the service logic block set. For example, as shown in FIG. 4, for example, service logic block set 5 can be executed after service logic block set 8. As shown in FIG. 6, the service logic block set 5 itself includes a logic block g and a logic block h, for example, in the process of executing the service logic block set 5, the logic block g and the logic block h can be executed in a predetermined internal order.

In the actual production scenario, in addition to adding new service or deleting expired service, the processing logic of existing service is often added or deleted. In order to facilitate the addition or deletion of processing logic for existing services, in one implementation, the maintainer corresponding to the service logic block set can add or remove logic blocks from the service logic block set.

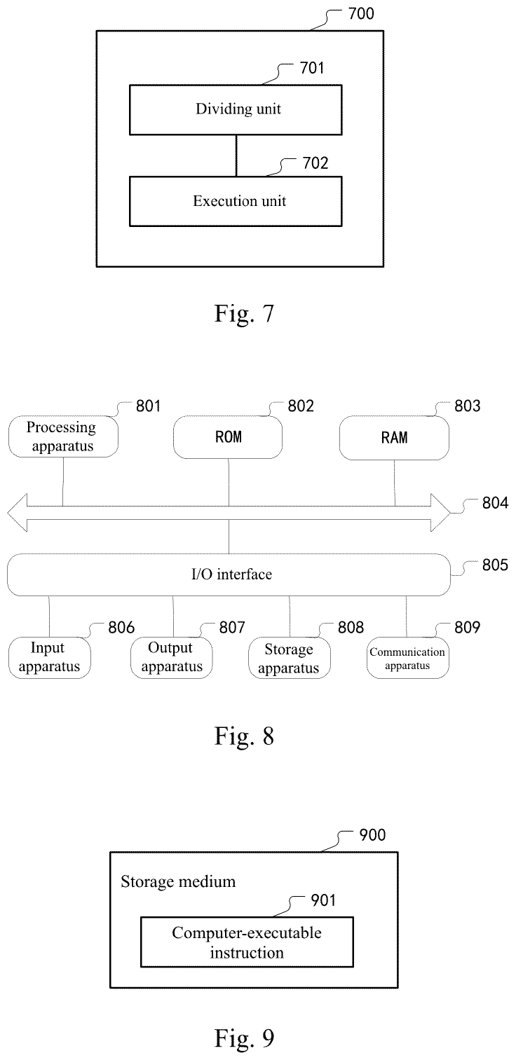

FIG. 7 shows a schematic block diagram of an apparatus for executing program service logic according to embodiments of the present disclosure. The apparatus is use for executing that method shown in FIG. 3. As shown in FIG. 7, the apparatus 700 includes:

A dividing unit 701, which is configured to divide a plurality of logic blocks included in a target program into a plurality of service logic block sets according to a service to which a logic block belongs, wherein each service logic block set of the plurality of the service logic block sets includes one or more logic blocks; and

An execution unit 702, which is configured to o concatenate the plurality of the service logic block sets into a service logic chain, wherein the service logic chain is used for executing respective service logic block set in sequence according to an order of the respective service logic block in the service logic chain.

Embodiments of the present disclosure also provide an electronic device, including a memory and a processor, wherein the memory stores executable codes, and when the processor executes the executable codes, the method shown in FIG. 3 is realized.

Next, reference can also be made to FIG. 8, which shows a structural schematic diagram of an electronic device 800 suitable for implementing embodiments of the present application. The electronic device 800 shown in FIG. 8 is only an example, and should not bring any limitation to the function and application scope of the embodiments of the present application.

As shown in FIG. 8, an electronic device 800 may include a processing apparatus (e.g., a central processing unit, a graphics processor, etc.) 801. The processing apparatus 801 may be a general processor, a Digital Signal Processing (DSP), a microprocessor or a microcontroller, and may further include an application specific integrated circuit (ASIC), Field-Programmable Gate Array (FPGA) or other programmable logic devices, discrete gate or transistor logic devices, and discrete hardware components, which can perform various appropriate actions and processes according to programs stored in read-only memory (ROM) 802 or programs loaded into random access memory (RAM) 803 from storage apparatus 808. In the RAM 803, various programs and data required for the operation of the electronic device 800 are also stored. The processing apparatus 801, ROM 802 and RAM 803 are connected to each other through a bus 804. An input/output (I/O) interface 805 is also connected to the bus 804.

Generally, the following apparatuses can be connected to the I/O interface 805: an input apparatus 806 including, for example, a touch screen, a touch pad, a keyboard, a mouse, etc.; An output apparatus 807 including, for example, a Liquid Crystal Display (LCD), a speaker, a vibrator, etc. Includes a storage apparatus 808 such as a magnetic tape, a hard disk, etc. And a communication apparatus 809. The communication apparatus 809 may allow the electronic device 800 to communicate wirelessly or wired with other devices to exchange data. Although FIG. 8 shows an electronic device 800 with various devices, it should be understood that it is not required to implement or have all the devices shown. More or fewer apparatuses may alternatively be implemented or provided. Each block shown in FIG. 8 may represent one device or a plurality of devices as required.

In particular, according to embodiments of the present application, the process described above with reference to the flowchart can be implemented as a computer software program. For example, embodiments of the present application include a computer program product, which includes a computer program carried on a computer-readable medium, and the computer program contains program code for executing the method shown in the flowchart. In such embodiments, the computer program can be downloaded and installed from the network through the communication apparatus 809, or installed from the storage apparatus 808, or installed from the ROM 802. When the computer program is executed by the processing apparatus 801, the above functions defined in the method for executing program service logic provided by the embodiments of the present application are executed.

The embodiments of the present disclosure also provide a computer-readable storage medium, on which a computer program is stored, and when the computer program is executed in a computer, the computer is caused to execute the method for executing program service logic as shown in FIG. 3 provided by the embodiments of the present application. FIG. 9 is a schematic diagram of a storage medium according to embodiments of the present application. For example, as shown in FIG. 9, the storage medium 900 may be a non-transitory computer-readable storage medium for storing non-transitory computer-executable instruction 901. When the non-transitory computer-executable instruction 901 is executed by the processor, the method for executing program service logic provided by the embodiments of the present application can be realized. For example, when the non-transitory computer-executable instruction 901 is executed by the processor, one or more steps of the method of executing program service logic provided by the embodiments of the present application can be executed. For example, the storage medium 900 can be applied to the above-mentioned electronic device, and for example, the storage medium 900 can include a memory in the electronic device. The description of the storage medium 900 can refer to the description of the memory in the embodiments of the electronic device, and the repetition is not repeated here. The specific functions and technical effects of the storage medium 900 can refer to the description of the method for executing program service logic provided by the embodiments of the present application, which is not repeated here.

It should be noted that the computer-readable medium of the embodiments of the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a memory card of a smart phone, a storage part of a tablet computer, a portable computer disk, a hard disk of a personal computer, a random access memory (RAM), a read-only memory (ROM), an erasable programmable read-only memory (EPROM or flash memory), an optical fiber, a portable compact disk read-only memory (CD-ROM), an optical storage device, and a magnetic device. In embodiments of the present disclosure, a computer-readable storage medium can be any tangible medium containing or storing a program, which can be used by or in combination with an instruction execution system, apparatus or device. In the embodiments of the present disclosure, the computer-readable signal medium may include a data signal propagated in baseband or as a part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (Radio Frequency), etc., or any suitable combination of the above.

The computer-readable medium may be included in the electronic device; or, it can exist alone without being assembled into the electronic device. The computer-readable medium carries one or more programs, and when the one or more programs are executed by the server, the electronic device can realize the method for executing program service logic provided by the embodiments of the present disclosure.

Computer program codes for performing the operations of embodiments of the present disclosure may be written in one or more programming languages or their combinations, including object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet with an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logic functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions. The units involved in the embodiments described in the present disclosure can be realized by software or hardware. Among them, the name of the unit does not constitute the limitation of the unit itself in some cases. The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

Embodiments of the present disclosure are described in a progressive way, and only the same and similar parts between the embodiments can be referred to each other, and each embodiment focuses on the differences from other embodiments. Especially, for the storage medium and the computing device embodiments, because it is basically similar to the method embodiment, the description is relatively simple, and the relevant points can only be found in part of the description of the method embodiments.

The above description is only the preferred embodiments of the present disclosure and the explanation of the applied technical principles. It should be understood by those skilled in the art that the disclosure scope involved in the present disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure. Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

The above specific implementations further explain the purpose, technical scheme and beneficial effects of the embodiments of the present invention in detail. Although the subject matter has been described in language specific to structural features and/or methodological acts, it should be understood that the subject matter defined in the appended claims is not necessarily limited to the specific features or acts described above. On the contrary, the specific features and methodological acts described above are only exemplary forms of implementing the claims. It should be understood that the above is only the specific implementations of the embodiments of the present invention, and it is not used to limit the protection scope of the present invention. Any modification, equivalent substitution, improvement, etc. made on the basis of the technical scheme of the present invention should be included in the protection scope of the present invention.

What is claimed is:

1. A method for executing program service logic, comprising:
dividing a plurality of logic blocks comprised in a target program into a plurality of service logic block sets according to a service to which a logic block belongs, wherein each service logic block set of the plurality of the service logic block sets comprises one or more logic blocks; and
concatenating the plurality of the service logic block sets into a service logic chain, wherein the service logic chain is used for executing respective service logic block set in sequence according to an order of the respective service logic block in the service logic chain.

2. The method of claim 1, further comprising:
removing a specified first service logic block set from the service logic chain; and
if there are an upper-level service logic block set and a lower-level service logic block set of the first service logic block set, linking the lower-level service logic block set behind the upper-level service logic block set.

3. The method of claim 1, further comprising:
inserting a specified second service logic block set at a specified position in the service logic chain;
if there is an upper-level logic block set at the specified position of the service logic chain, linking the second service logic block set after the upper-level logic block set; and
if there is a lower-level logic block set at the specified position of the service logic chain, linking the lower-level logic block set to the second service logic block set.

4. The method of claim 1, wherein the service logic chain further comprises an asynchronous service logic block set, which is executed asynchronously with other service logic block sets in the service logic chain.

5. The method of claim 4, wherein the asynchronous service logic set executing asynchronously with other service logic block sets in the service logic chain, comprising:
executing the other service logic block sets by a main thread of the service logic chain, and executing the asynchronous service logic set by other threads other than the main thread.

6. The method of claim 1, further comprising:
adding or removing a logic block in a service logic block set by a maintainer corresponding to the service logic block set.

7. The method of claim 1, wherein executing any service logic block set of the plurality of the service logic block sets comprises: sequentially executing each logic block according to an internal order of the each logic block comprised in a service logic block set.

8. The method of claim 1, wherein the target program is a client program, and the logic block is used for data processing for the service to which the logic block belongs.

9. An electronic device comprising a non-transitory memory and a processor, wherein machine-readable instructions are stored in the memory, and the machine-readable instructions, when executed by the processor, cause the processor to:
divide a plurality of logic blocks comprised in a target program into a plurality of service logic block sets according to a service to which a logic block belongs, wherein each service logic block set of the plurality of the service logic block sets comprises one or more logic blocks; and
concatenate the plurality of the service logic block sets into a service logic chain, wherein the service logic chain is used for executing respective service logic block set in sequence according to an order of the respective service logic block in the service logic chain.

10. The electronic device of claim 9, wherein the machine-readable instructions further cause the processor to:
remove a specified first service logic block set from the service logic chain; and
if there are an upper-level service logic block set and a lower-level service logic block set of the first service logic block set, link the lower-level service logic block set behind the upper-level service logic block set.

11. The electronic device of claim 9, wherein the machine-readable instructions further cause the processor to:
insert a specified second service logic block set at a specified position in the service logic chain;
if there is an upper-level logic block set at the specified position of the service logic chain, link the second service logic block set after the upper-level logic block set; and
if there is a lower-level logic block set at the specified position of the service logic chain, link the lower-level logic block set to the second service logic block set.

12. The electronic device of claim 9, wherein the service logic chain further comprises an asynchronous service logic block set, which is executed asynchronously with other service logic block sets in the service logic chain.

13. The electronic device of claim 12, wherein the asynchronous service logic set executing asynchronously with other service logic block sets in the service logic chain, comprising:
executing the other service logic block sets by a main thread of the service logic chain, and executing the asynchronous service logic set by other threads other than the main thread.

14. The electronic device of claim 9, wherein the machine-readable instructions further cause the processor to:
add or remove a logic block in a service logic block set by a maintainer corresponding to the service logic block set.

15. The electronic device of claim 9, wherein executing any service logic block set of the plurality of the service logic block sets comprises: sequentially executing each logic block according to an internal order of the each logic block comprised in a service logic block set.

16. The electronic device of claim 9, wherein the target program is a client program, and the logic block is used for data processing for the service to which the logic block belongs.

17. A non-transitory computer-readable storage medium storing instructions that cause a processor to:
divide a plurality of logic blocks comprised in a target program into a plurality of service logic block sets according to a service to which a logic block belongs, wherein each service logic block set of the plurality of the service logic block sets comprises one or more logic blocks; and
concatenate the plurality of the service logic block sets into a service logic chain, wherein the service logic chain is used for executing respective service logic block set in sequence according to an order of the respective service logic block in the service logic chain.

18. The non-transitory computer-readable storage medium of claim 17, wherein the instructions further cause the processor to:
remove a specified first service logic block set from the service logic chain; and
if there are an upper-level service logic block set and a lower-level service logic block set of the first service logic block set, link the lower-level service logic block set behind the upper-level service logic block set.

19. The non-transitory computer-readable storage medium of claim 17, wherein the instructions further cause the processor to:
insert a specified second service logic block set at a specified position in the service logic chain;
if there is an upper-level logic block set at the specified position of the service logic chain, link the second service logic block set after the upper-level logic block set; and
if there is a lower-level logic block set at the specified position of the service logic chain, link the lower-level logic block set to the second service logic block set.

20. The non-transitory computer-readable storage medium of claim 17, wherein the service logic chain further comprises an asynchronous service logic block set, which is executed asynchronously with other service logic block sets in the service logic chain.
